(19) United States
(12) Patent Application Publication
(10) Pub. No.: US 2007/0114100 A1
(43) Pub. Date: May 24, 2007

(54) WHEEL CASTER WITH WHEEL CHOCK

(76) Inventor: Steven S. JOHNDREAU, Rocklin, CA (US)

Correspondence Address: GROSS & ASSOCIATES, 1415 L STREET SUITE 1000, SACRAMETO, CA, 95814, US

(21) Appl. No.: 11/561,934

(22) Filed: Nov. 21, 2006

Related U.S. Application Data
(60) Provisional application No. 60/738,791, filed on Nov. 21, 2005.

(51) Int. Cl. B62B 5/04

(52) U.S. Cl. 188/19

(57) ABSTRACT

The present invention is a device for supporting a wheel comprising a first member, which has a retention member and an axle operably configured to receive the wheel, and; a second member, which has a chock and an engagement portion. The second member is rotatably attached to the axle. Further, the second member is operably configured to have an unchocked position when not in use and selectively rotatable to a chocked position against the wheel to keep the wheel from rotating in at least one of a forward and reverse direction when the second member is use. Additionally, the retention member retains the engagement portion of the second member in the unchocked position when the chock is not in use.

### CROSS REFERENCE TO RELATED APPLICATION

This nonprovisional application claims the benefit of Provisional Application No.: 60/738,791, filed on Nov. 21, 2005, which is incorporated herein by reference in its entirety and to which priority is claimed.

### BACKGROUND OF THE INVENTION

1. Field of Invention

The present invention relates to a chock device incorporated into a removable wheel caster for sports equipment such as, but not limited to, baseball pitching machines, protective screens and the like.

2. Description of Related Art

Coaches and players use conventional standing sports equipment or baseball devices such as pitching machines, L-screens, batting cages, position protection screens and the like to protect players and coaches during practice. Most of the conventional standing sports equipment devices must be carried or dragged from a storage area to the playing field, because they do not have wheels.

Most of such conventional sports equipment do not have wheels because they need to remain stationary when in use. Newer models are starting to be developed which incorporate some sort of wheels. However, these conventional devices fail to provide a means of keeping the conventional sports equipment stationary.

For those sport teams that do not have newer conventional sports equipment, conventional removable casters, such as the device disclosed in Johndreau 7,042,309, are available for moving the conventional sports equipment However, these conventional wheel casters must be removed before the device can be used, because these conventional wheel casters fail to provide a means to keep the conventional sports equipment stationary. Additionally, once removed, the conventional wheel casters must be carried off the field of practice or they will become an injury hazard.

### SUMMARY OF INVENTION

It is an object of the present invention to overcome the drawbacks and shortcomings of conventional wheel casters for conventional standing sports equipment. Particularly, most conventional standing sports equipment devices do not provide an efficient way to move the equipment from a storage area to the playing field and back. The present invention provides a wheel caster with a built in wheel chock that can be incorporated into the construction of conventional standing sports equipment to ease the placement of the conventional standing sports equipment on and off the playing field.

The present invention further provides an embodiment wherein a removable wheel caster with a built in chock is provided to be attached to conventional standing sports equipment keeping the conventional standing sports equipment stationary.

The present invention is a device for supporting a wheel comprising a first member, which has a retention member and an axle operably configured to receive the wheel, and; a second member, which has a chock and an engagement portion. The second member is rotatably attached to the axle. Further, the second member is operably configured to have an unchocked position when not in use and selectively rotatable to a chocked position against the wheel to keep the wheel from rotating in at least one of a forward and reverse direction when the second member is use. Additionally, the retention member retains the engagement portion of the second member in the unchocked position when the chock is not in use.

Additionally, the present is a removable wheel caster device for a pitching machine support stand that comprises a first member; a support sleeve disposed on the first member and operably configured to receive a leg of the pitching machine; an axle connected to the first member and operably configured to receive a wheel; and, a second member having a chock portion and being rotatably attached to the axle. The second member is selectively rotatable between a chocked position when in use, and an unchecked position when not in use. The first member is operably configured to retain the second member in the unchecked position when the second member is not in use.

Still further, the present invention presented in an alternative embodiment is a caster device for supporting a wheel and for attachment to a structure having a non-rotating axle comprising a first member having a retention member and operably configured to engage the non-rotating axle; a second axle having an engagement portion and being connected to the first member and operably configured to receive the wheel; and, a chock member having a chock and an engagement portion. The chock member is rotatably attached to the second axle, wherein the chock member is operably configured to have an unchocked position when not in use and selectively rotatable to a chocked position against the wheel to keep the wheel from rotating in at least one of a forward and reverse direction when the chock member is use. Further, the retention member retains the engagement portion of the chock member in the unchocked position when the chock is not in use.

### BRIEF DESCRIPTION OF FIGS.

Various exemplary embodiments of this invention will be described in detail, with reference to the following figures, wherein:

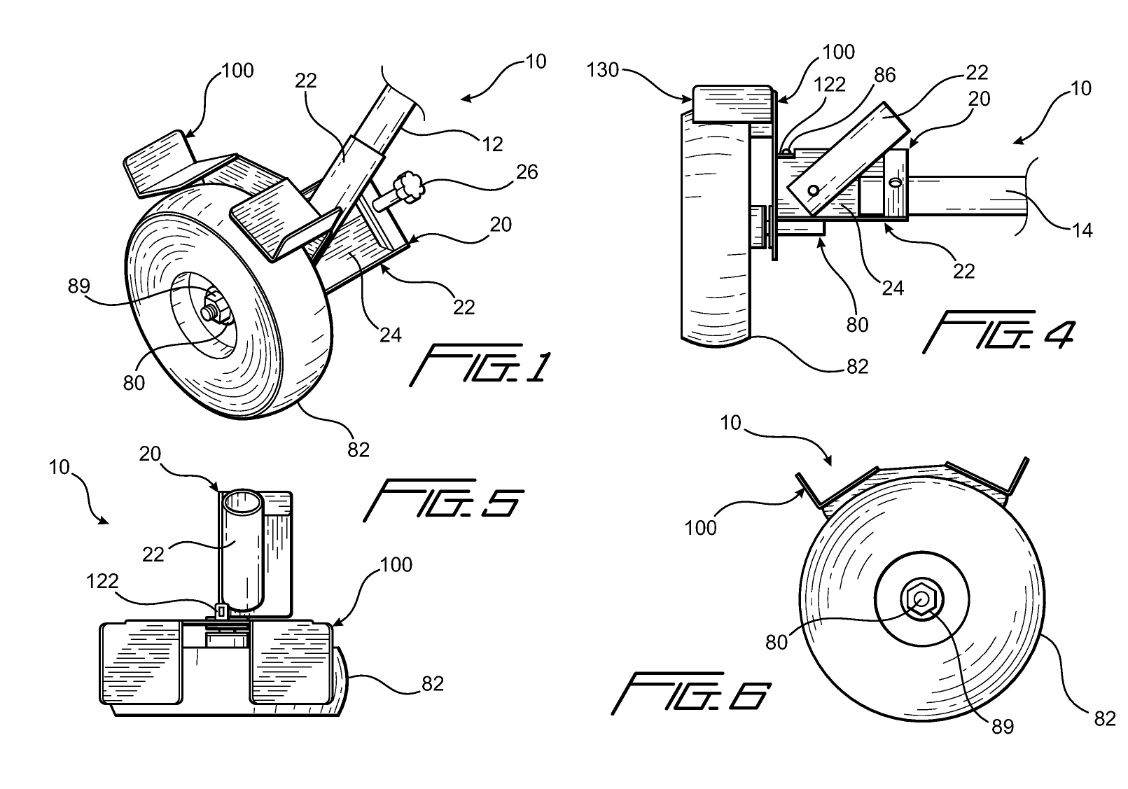

FIG. 1 is a perspective view a wheel caster device in a first position made according to this invention;

FIG. 2 is an exploded perspective view of the wheel caster device of FIG. 1;

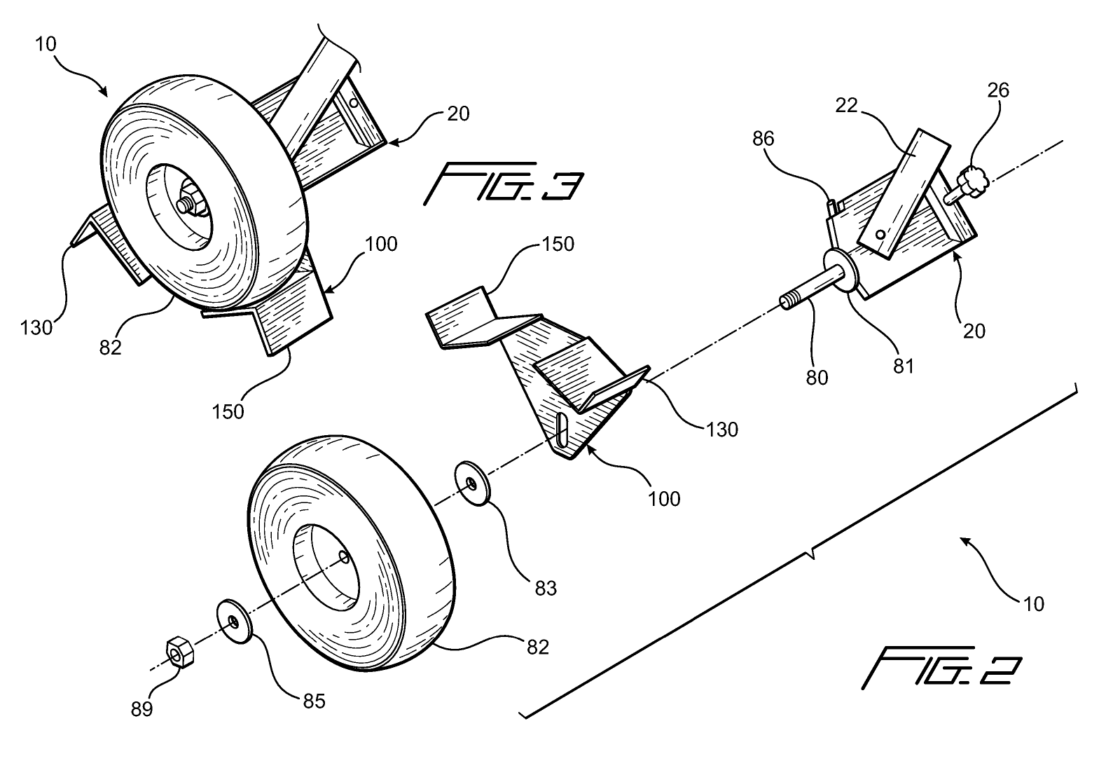

FIG. 3 is a perspective view of the wheel caster device of FIG. 1 in a second position;

FIG. 4 is a front view of the wheel caster device of FIG. 1;

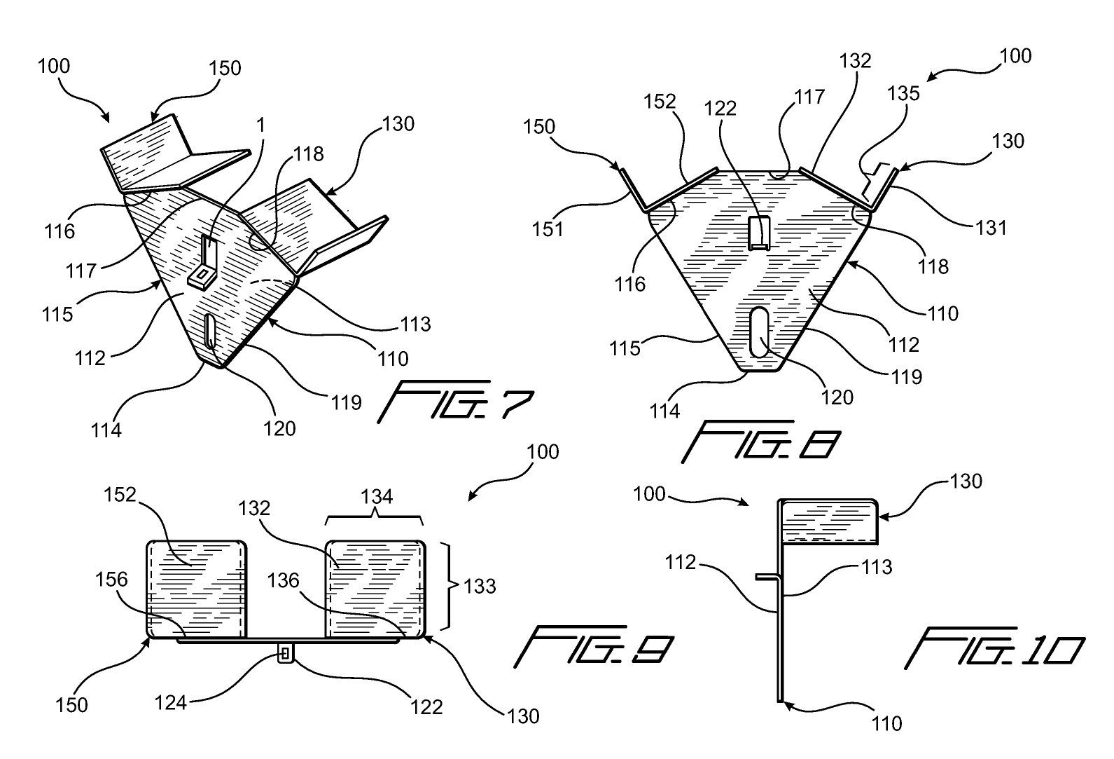

FIG. 5 is a top view of the wheel caster device of FIG. 1;

FIG. 6 is a side view of the wheel caster device of FIG. 1;

FIG. 7 is a perspective view of a chock of the wheel caster device of FIG. 1, made according to this invention;

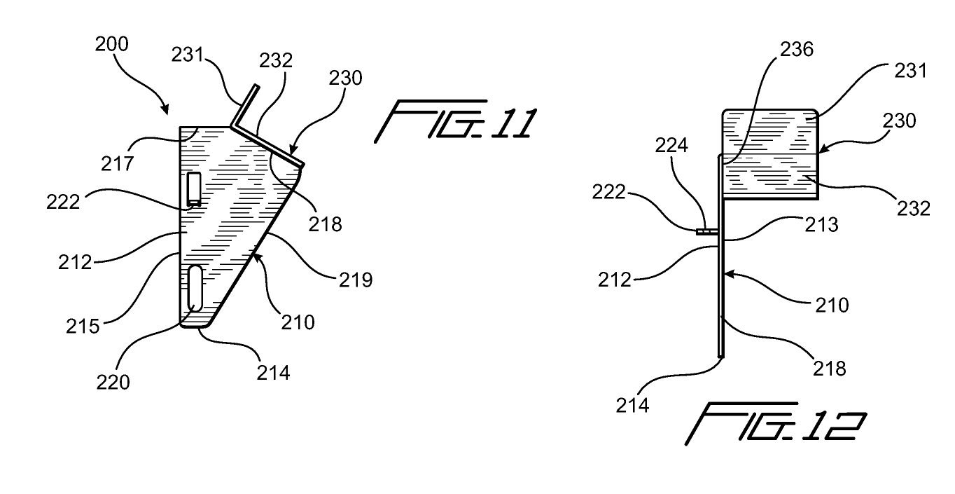

FIG. 8 is a side view of the chock of FIG. 7;

FIG. 9 is a top view of the chock of FIG. 7,

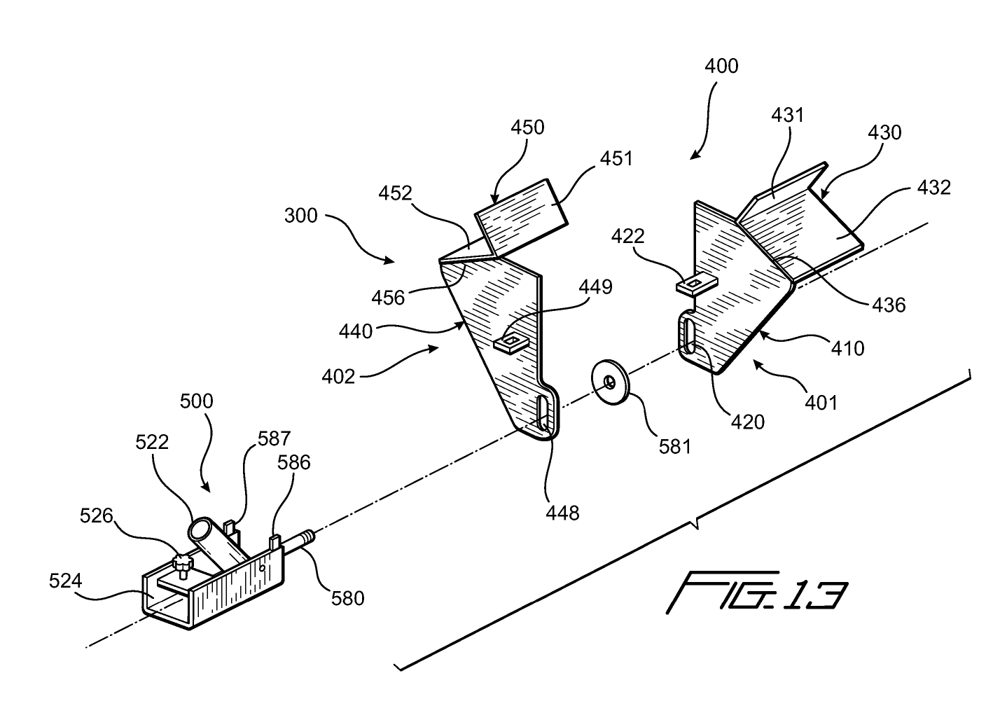

FIG. 10 is rear view of the chock of FIG. 7;

FIG. 11 is a side of an alternative embodiment of a chock made in accordance with this invention;

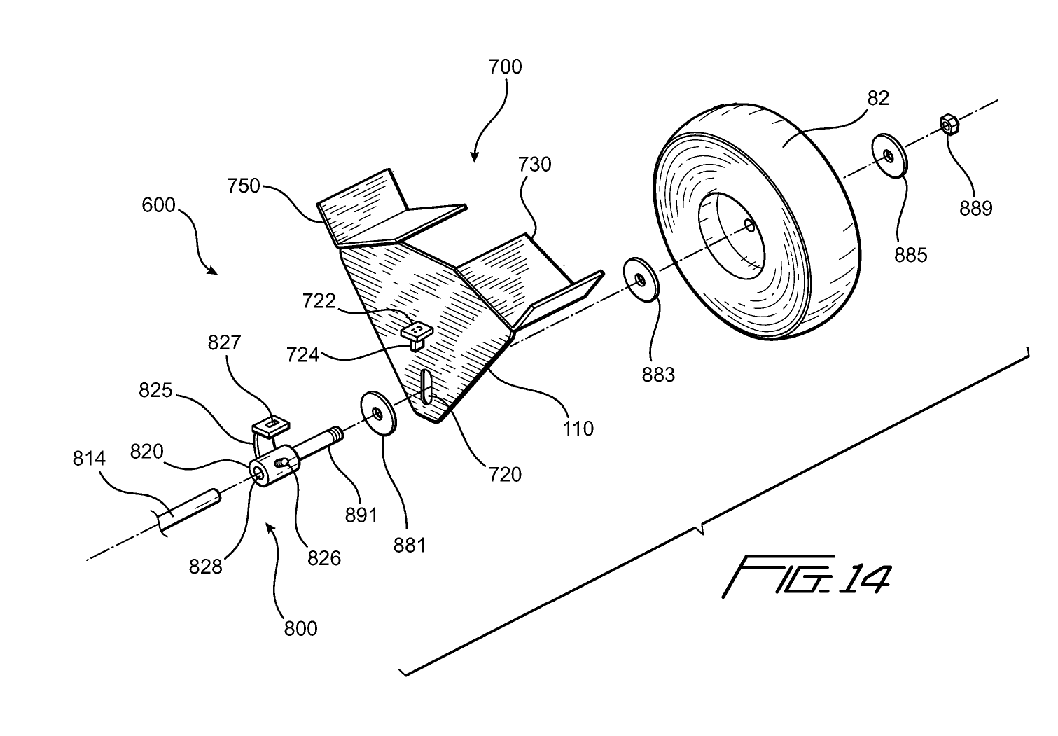

FIG. 12 is a rear view of the chock of FIG. 11;

FIG. 13 is an exploded view of an alternative embodiment of a wheel caster made in accordance with this invention; and,

FIG. 14 is another exploded view of an alternative embodiment of a wheel caster made in accordance with this invention.

### DETAILED DESCRIPTION OF INVENTION

This application incorporates herein by reference U.S. Pat. No.: 7,042,309, issued on May 9, 2006, which relates to Casters for an Automatic Ball Throwing Device.

The present invention provides a device 10 having an first member or axle housing 20 and a second member or chock member 100, as shown in FIG. 1. The device 10 can be removably attached to conventional standing sports equipment, such as, but not limited to pitching machines, L-screens and batting cages.

The removable wheel caster device 10, as shown in FIGS. 1 through 6 is generally for placement on a piece of equipment that has bottom supports with exposed ends. An example of employment of the device 10 is on L-screens used to protect batting practice pictures in baseball, an extension of a leg 14 is shown in FIG. 2. By attaching the caster 10 to each end of the generally horizontally oriented leg 14 on-the L-screen, one person or user can roll and maneuver the L-screen around a practice field instead of two people carrying it. It should be appreciated that in other various exemplary embodiments, the device could be used on other items needing a removable wheel. In the present embodiment, the removable wheel caster device can be placed on the leg of an L-screen up to a size of two-inch in diameter. Further, it should be appreciated that in other exemplary embodiments, the removable wheel caster can be manufactured to except a variety of sized legs.

Another example of employment is on generally vertically oriented legs 12 of a pitching machine. An extension of the leg 12 is shown in FIG. 1. The wheel caster device 10 is operably configured to receive legs from sports equipment in the vertical direction, such as, but not limited to, pitching machines or other devices with similar tripods legs. The wheel caster device 10 is held in place by the weight of the equipment. For sports equipment with tripod legs, generally two casters are used.

Once the conventional sports equipment is in place, the user can then set the chock or second member 100, as shown in FIG. 3. By setting the chock 100, there is no need to remove the wheel caster from the conventional sport equipment.

The device 10 constructed out of a rugged durable material. In the preferred example ⅛ inch angled steel is used. It should be appreciated that in other exemplary embodiments, other similar materials common in the art may be used, such as, but not limited to, harden plastic or aluminum for example.

The first member or axle housing 20 is similar to the axle housing disclosed in U.S. Pat. No. 7,042,309. The axle housing 20 is operably configured to receive a structure member of sports equipment such as the vertically oriented leg 12, as shown in FIG. 1 or the horizontally oriented leg 14 as shown in FIG. 4. The axle housing 20 includes a pivotably attached sleeve or support tube 22, wherein the support tube 22 is operably configured to receive the vertically oriented leg 12. The weight of the pitching machine holds the vertically oriented leg 12 in the sleeve 22. The axle housing 20 further includes an open interior 24 operably configured to receive the horizontally oriented leg 14.

The first member 20 further includes a threaded pin 26. The threaded pin 26 us to apply pressure against the horizontally oriented leg 14. The pivotably attached sleeve 22 in the wheel caster device 10 is operably configured to receive legs from the tripod legged equipment. The pivotably attached sleeve 22 allows for adjustment in the varying angles between difference sports equipment. The pivotably attached sleeve 22 has a diameter, wherein the diameter is larger than the diameter of the leg 12. It should be appreciated that in other various exemplary embodiments, the support tube may also include a threaded pin to aid in the retention of the vertical leg.

Further, the axle house 20 in the present embodiment shows two examples of how the axle housing 20 can be attached to structural members of sports equipment. However, it should be appreciated that in other various exemplary embodiments, the axle housing may be attached by other methods common in the art, such as but not limited to, hinge portions or threaded sleeves for example.

The axle housing 20 further includes an axle 80 operably configured to receive a wheel 82. The axle 80 is fixedly attached to one end of the first member 20 and the wheel 82 is rotatably attached to the axle 80. The chock 100 is rotatably disposed on the axle 80 between the wheel 82 and the axle housing 20, as shown in FIGS. 1 through 6. In particular, FIG. 1 shows the chock 100 in a first or stored position. FIG. 3 shows the chock 100 is a second or in-use position.

Additionally, the device 10 includes a plurality of washers. A first washer 81 is between the chock and the axle housing 20, a second washer 83 is between the chock 100 and the wheel 82 and a third washer 85 is between the wheel and a retaining nut 89, as shown in FIG. 2. In the present embodiment, the first washer 81 is fixedly attached to the axle housing 20. However, it should be appreciated that in other various exemplary embodiments, the first washer need not be fixedly attached to the axle housing.

Further, in the present embodiment, the wheel 82 is retained on the axle 80 by the retaining nut 89. It should be appreciated that in other various exemplary embodiments, other methods common in the art may be used to retain the wheel to the axle, such as for example a cotter pin.

In the present embodiment, the axle housing 20 has a generally L-shaped profile. It should be appreciated that in other various exemplary embodiments, other types and styles of axle housing may be used. Various examples of possible alternate embodiments for the axle housing will be discussed below.

Additionally, the axle housing has a retention member or locking tong 86. The locking tong 86 is disposed on the same end of the axle housing 20 as the axle 80. The present embodiment, the tong 86 is disposed in a recess in a vertical portion of the L-shaped housing 20. It should be appreciated that in other various exemplary embodiments the tong could be a vertical tong not in a recess, but on the top of the vertical portion of the L-shaped housing.

The second member or chock member 100, as shown in FIGS. 1, is in the first position. The first position is a non-use, unchocked or stored position. FIGS. 3 shows the chock 100 is the second or in-use position. In the second position, the chock 100 is under the wheel 82. The chock 100 keeps whatever conventional sports equipment the device 100 is mounted to from moving.

Now referring to FIGS. 7 through 10, the chock 100 includes three portions, 110, 130 and 150. The first portion 110 includes a first surface 112 and a second surface 113. The chock 100 has a perimeter comprising of six edges, a first or bottom edge 114, a second edge 115, a third or angle edge 116, a fourth or top edge 117, a fifth edge 118 and a sixth edge 119. The first portion 110 further include an axle orifice 120 disposed on the first surface 112 in proximity to the first or bottom edge 114 and such that the orifice 120 penetrates through the first portion 110 to the second surface 113. The axle orifice 120 in the present embodiment is elongated to allow the chock 100 to be moved rotatably about the axle 80.

In the present embodiment, the chock 100, and the first, second and third portions 110, 130 and 150 are all integral and constructed out of steel. It should be appreciated that in other various exemplary embodiments, the chock and the first, second and third portions are not integral. Additionally, it should also be appreciated that in other various exemplary embodiments the chock, first, second and third portions are constructed out of other materials such as aluminum or plastic for example.

The first portion 110 additionally includes an engagement portion or tab 122. The tab 122 is disposed on the first surface 112 of the first portion 110. The first surface 112 is oriented towards the axle housing 20. The tab 122 is generally perpendicular to and outward from the first surface 112. The tab 122 has a locking orifice 124. The axle orifice 120 and tab 122 are aligned vertically on the first surface 112 of the first portion 110, as shown in FIG. 8. The locking orifice 124 is operably configured to receive the locking tong 86 on the axle housing 20.

The second portion 130 has two planar portions 131 and 132. The two planar portions 131 and 132 are disposed adjacent-to each other to form an L-shape. The second portion 130 is disposed on the first portion 110 along the fifth edge 118 such that a side 136 of the second planar portion 132 is along the fifth edge 118 and the first planar portion 131 is aligned with the sixth edge 119, as shown in FIGS. 7 and 8.

Further, the first planar portion 131 has a height 135. The second planar portion 132 has a length 134. The two planar portions 131 and 132 have equal widths 133. The length 134 of the second planar portion 132 is equal to the length to of the fifth edge 118.

The third portion 150 is similar to the second portion 130. The third portion has two planar portions 151 and 152. The difference is that the third portion is disposed adjacent to the third edge 116 of the first portion 110, and the second planar portion 152 is aligned with the second edge 115.

It should be appreciated that in other various exemplary embodiments, the first and third portions could be removably attached to the first portion. Further, the first and third portions could be in other various exemplary embodiments, constructed out of other material, such as but not limited to, wedge shaped blocks of rubber or hard plastic for example.

As mentioned above, the chock 100 is rotatably disposed on the axle 80 between the axle housing 20 and the wheel 82. In the first position, the chock 100 is positioned such that the first and second portions 130 and 150 are above the wheel 82, and the locking tong 86 is engaged in the locking orifice 124. The chock 100 can be lifted by the user along the elongated axle orifice 120. The tab 122 is lifted from the locking tong 86. The chock 100 is now free to rotate about the axle. The user lifts up on the conventional sports equipment and continues to rotate the chock 100 until the chock 100 is in the second or in-use position, as shown in FIG. 3. In the second position, the chock 100 is positioned under the wheel 82 with the fourth edge 117 along the ground surface.

In the present embodiment, the tab 122 is made by cutting the first portion 110 with two vertical cuts and a connecting horizontal cut. The tab 122 is then bent to the horizontal position. It should be appreciated that in other various exemplary embodiments, the tab could be manufactured in by other means common in the art, such as for example welding a prefabricated tab to the chock.

The tab 122, locking tong 86 and locking orifice 124 are what hold the chock 100 in the first or stored position. However, it should be appreciated that in other various exemplary embodiments, the chock could be held in the first position by other means common in the art, such as but not limited to, a spring biased ball into a detent, for example.

Further, it is anticipated by the present invention that in other various exemplary embodiments, wheel bearings may be used in combination with the axle and the wheel as is common in the art.

Additionally, while the present embodiment of the device 10 is described for use with sports equipment, is should be appreciated that in other various exemplary embodiments the wheel caster device may be used in conjunction with other devices such as but not limited to, wagons, carts lawn chairs, etc.

The chock 100 of the device 10 of the present embodiment will chock the wheel 82 on both sides of the wheel preventing the wheel 82 from rolling in either direction. However, it should be appreciated that in other various exemplary embodiments, the chock may only be able to stop the wheel in one direction. Alternately, in another exemplary embodiment, the chock may be selectable in order to stop the wheel in either direction. Discussions about possible examples of alternate embodiments will be provided below.

FIGS. 11 and 12 are front and rear view of a chock 200. The chock 200 is an alternative exemplary embodiment of the chock 100 in the device 10, made in accordance with the present invention. The chock 200 is similar to the chock 100 as described above. The chock 200 has a first portion 210 and a second portion 230. The first and second portions 210 and 230 are similar to the first and second portions 110 and 130 of the chock 100 described above. Further, the second portion includes has two planar portions 231 and 232 as in the second portion 130 of chock 100.

The chock 200 is different form the chock 100 in that the chock 200 does not have a third portion. Further, the chock 200 is different in that the first portion 210 has five edges vice six edges, 214, 215, 217, 218 and 219. Further, the chock 200 can be used on only one side of the wheel 82.

Still further, the chock 200 is different from the chock 100 in that the two planar portions 231 and 232 are disposed adjacent to each other to form an L-shape, as shown in FIG. 11. The second portion 230 is disposed on the first portion along the fourth edge 218 such that a side 236 of the second planar portion 232 is along the fourth edge 218. The first planar portion 231 is disposed at the junction of the third edge 217 and the fourth edge 218 and is generally perpendicular to the second planar portion 232.

The chock 200 like the chock 100 has an first or stored position and a second or in-use position. When in the second position, the chock 200 can only stop the wheel from moving in one direction at a time.

FIG. 13 is an exploded perspective view of a device 300 having a chock 400 and an axle housing 500. The device 300, the chock 400 and the axle housing 500 are alternative exemplary embodiments of the device 10, chock 100 and axle housing 20, made in accordance with the present invention. A wheel is not shown in FIG. 13.

The chock 400 is similar to the chock 100 as described above. The chock 400 has a first portion 410 and a second portion 430. The first and second portions 410 and 430 are similar to the first and second portions 110 and 130 of the chock 100 described above. Further, the first and second portions 410 and 430 are similar to the first and second portions 210 and 230 of the chock 200.

The chock 400 is different from the chock 100 in that the chock 400 has two members 401 and 402. The first member 401 is similar to the chock 200. The first member 401 has a first portion 410 and a second portion 430. Additionally, the first part 401 like chock 200 has an axle orifice 420, a tab 422, an axle orifice 420, a first planar portion 431 and a second planar portion 432.

The first member 401 is different from the chock 200 in that the tab 422 is longer than the tab 222. Additionally the axle orifice 420 and the tab 422 are not vertically aligned. The orifice 420 is offset vertically from the tab 422.

The second member 402 is a mirror image of the first member 401 as shown in FIG. 13. The second member 402 includes a first portion 440 and a second portion 450. Additionally the second member 402 has an axle orifice 448 and a tab 449. The orifice 448 is offset vertically from the tab 449. The tab 449 is different from the tab 422 of the first member 401 in that the tab 449 is shorter and the same size as the tabs 122 and 222 of the chocks 100 and 200 respectively.

The axle housing 500 is similar to the axle housing 20 described above. The axle housing 500 includes a pivotably connected support tube 522, an open interior 524, a threaded pin 526 and an axle 580. The axle housing 500 further include a tong 586 similar to the tong 86 in the axle housing 20.

The axle housing 500 is different from the axle housing 20 in that the axle housing 500 has a generally U-shaped profile. Additionally, the axle housing 500 includes a second tong 587. The tab 422 is operably configured to engage tong 586 and the tab 449 is operably configured to engage tong 587.

In the device 300, the axle housing 500 receives the washer 581, then the first member 401 of chock 400, followed by the second member 402 of the chock 400. Both the first member 401 and the second member 402 are independently rotatably attached to the axle 580.

The device 300 offers the user a choice of which direction of the wheel (not shown) that the user desires to block. In a first direction the user would use the first member 401 of the chock 400. In a second direction, the user would use the second member 402 of the chock 400. Or, if the user so chooses, both the first and second members 401 and 402 of the chock 400 may be used simultaneously.

FIG. 14 is an exploded perspective view of a device 600 having a chock 700 and an axle housing 800. The device 600, the chock 700 and the axle housing 800 are alternative exemplary embodiments of the device 10, chock 100 and axle housing 20, made in accordance with the present invention.

The chock 700 is similar to the chock 100 as described above. The chock 700 has a first portion 710, a second portion 730 and a third portion 750. The first, second and third portions 710, 730 and 750 are similar to the first, second and portions 110, 130 and 150 of the chock 100 described above. The chock 700 also includes an axle orifice 720 and a tab 722.

The chock 700 is different from the chock 100 in that the chock 700 does not include a locking orifice as in the chock 100. The chock 700 has a locking tab 724 as shown in FIG. 14.

The axle housing 800 is different from the axle housing 20 in that the axle housing 800 is operably configured to engage an existing axle 814, wherein the existing axle 814 is non-rotating. The axle housing 800 has main body 820. The main body 820 includes an axle orifice 828, a vertical support member 825 and a locking tab receiving orifice 827. The main body farther includes an extended axle 891 and a set screw 826. The extended axle 891 provides an axle to mount wheel 82. The axle housing 800 covers the existing axle 814. The extended axle 891 now becomes the axle to which the wheel 82 is mounted on. The set screw 826 is used to create pressure against the axle 814 holding the body 820 stationary relative to the axle 814. It should be appreciated that in other various exemplary embodiments, the main body may be permanently held stationary to the axle by means common in the art such as, but not limited to, key way or welding for example.

The axle housing 800 is placed on the existing axle 814. The washer 881 and chock 700 are placed on the extended axle 891. The chock 700 is rotatably disposed to the extended axle 891. The chock 700 remains in a first or non-use position by the locking tab 724 engaging the locking tab receiving orifice 827. The user lifts the chock 700 releasing the locking tab 724 from the locking tab receiving orifice 827. The chock 700 is now free to rotate about the extended axle 891 into a second or in-use position under the wheel 82.

Additionally, the device 600 is not limited to sports equipment. It should be appreciated that in other various exemplary embodiments, the device could be installed on other equipment, such as for example a cart or a child's wagon, for example.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device for supporting a wheel comprising:
a first member having a retention member and an axle operably configured to receive the wheel, and;
a second member having a chock and an engagement portion, and being rotatably attached to the axle, wherein the second member is operably configured to have an unchecked position when not in use and selectively rotatable to a chocked position against the wheel to keep the wheel from rotating in at least one of a forward and reverse direction when the second member is use, and
wherein the retention member retains the engagement portion of the second member in the unchocked position when the chock is not in use.

2. The device, as recited in claim 1, further comprising a support sleeve rotatably connected to the first member, wherein the support sleeve is operable configured to receive a generally vertically oriented leg from a structure.

3. The device, as recited in claim 1, wherein when the second member is in use the second member is rotatable to go between the wheel and a ground surface, so as to keep the wheel from rolling in a forward and reverse direction.

4. The device, as recited in claim 1, wherein the second member has a first and second chock, wherein the first chock keeps the wheel from rotating in the forward direction and the second chock keeps the wheel from rotating in the reverse direction.

5. The device, as recited in claim 1, wherein the second member further includes a second wheel chock, the first wheel chock being rotatable in a first direction and the second wheel chock being rotatable in a second opposite direction.

6. The device, as recited in claim 1, further comprising a threaded pin operably configured to thread through a threaded orifice of the first member and secure a generally horizontally oriented leg from a structure.

7. The device, as recited in claim 1, wherein the first member is operably configured to receive a non-rotating axle from a structure and the first member further includes an extending axle operably configured to receive the wheel and the second member.

8. The device, as recited in claim 1, wherein the axle is threaded and operably configured to receive a retaining nut.

9. A removable wheel caster device for a pitching machine support stand comprising:
a first member;
a support sleeve disposed on the first member and operably configured to receive a leg of the pitching machine;
an axle connected to the first member and operably configured to receive a wheel; and,
a second member having a chock portion and being rotatably attached to the axle, wherein the second member is selectively rotatable between a chocked position when in use; and, an unchecked position when not in use, and
wherein the first member is operably configured to retain the second member in the unchocked position when the second member is not in use.

10. The removable wheel caster device, as recited in claim 9, wherein the support sleeve is rotatably connected to the first member.

11. The removable wheel caster device, as recited in claim 9, wherein when the second member is in use the second member is rotatable to go between the wheel and a ground surface, so as to keep the wheel from rolling in a forward and reverse direction.

12. The removable wheel caster device, as recited in claim 9, wherein when the second member is in use the second member is rotatable to be positioned against the wheel, so as to keep the wheel from rolling in at least one of a forward and reverse direction.

13. The removable wheel caster device, as recited in claim 9, wherein the second member further includes a second chock portion, the first chock portion being rotatable in a first direction and the second chock portion being rotatable in a second opposite direction.

14. A caster device for supporting a wheel and for attachment to a structure having a non-rotating axle comprising:
a first member having a retention member and operably configured to engage the non-rotating axle;
a second axle having an engagement portion and being connected to the first member and operably configured to receive the wheel; and,
a chock member having a chock and an engagement portion, and being rotatably attached to the second axle, wherein the chock member is operably configured to have an unchocked position when not in use and selectively rotatable to a chocked position against the wheel to keep the wheel from rotating in at least one of a forward and reverse direction when the chock member is use, and
wherein the retention member retains the engagement portion of the chock member in the unchocked position when the chock is not in use.

15. The caster device, as recited in claim 14, wherein the chock member further includes a second chock, the first chock being rotatable in a first direction and the second chock being rotatable in a second opposite direction.

16. The caster device, as recited in claim 14, wherein when the chock member is in use the chock member is rotatable to go between the wheel and a ground surface, so as to keep the wheel from rolling in a forward and reverse direction.

17. The caster device, as recited in claim 14, wherein when the chock member is in use the chock member is rotatable to be positioned against the wheel, so as to keep the wheel from rolling in at least one of a forward and reverse direction.
